(19) United States
(12) Patent Application Publication
(10) Pub. No.: US 2014/0014143 A1
(43) Pub. Date: Jan. 16, 2014

(54) CONSTRUCTION MAT CLEANING MACHINE AND METHOD OF USE THEREOF

(71) Applicants: Roger Kevin Kennedy, Ralston, OK (US); James Brooks Hudson, Ralston, OK (US)

(72) Inventors: Roger Kevin Kennedy, Ralston, OK (US); James Brooks Hudson, Ralston, OK (US)

(73) Assignee: RIVERSIDE CUSTOM CLEANING, LLC, Tulsa, OK (US)

(21) Appl. No.: 13/545,533

(22) Filed: Jul. 10, 2012

(51) Int. Cl. B08B 11/02

(52) U.S. Cl. 134/115 R; 134/122 R

(57) ABSTRACT

A construction mat cleaning machine and a method of use thereof that do not use water, chemical agents or other aqueous or non-aqueous solvents during the cleaning process. The cleaning machine may be constructed on a semi-trailer so that it is portable between job sites. The cleaning machine conveys the construction mats in a generally horizontal orientation along a path of travel while all the surfaces and within the seams or gaps between the boards of construction mats are cleaned using a series of resilient cleaning rollers. After the cleaning process, the cleaning machine stacks the construction mats in an orderly fashion on the ground when exiting the cleaning machine.

### BACKGROUND OF THE INVENTION

1. Field of the Invention

This invention relates generally to a machine and method for cleaning construction mats, and more particularly to a construction mat cleaning machine and method of use thereof that does not use water, chemical agents or other aqueous or non-aqueous solvents.

2. Description of the Related Art

Construction mats have been used as platforms for supporting heavy equipment during construction or maintenance, and also to provide a solid road surface for construction equipment, trucks, and other vehicles needing to access unpaved construction or maintenance sites. The mats eliminate the need for the construction of gravel roads and platforms. Generally, construction mats are made from durable hardwoods, laminate, timber or composites formed in discrete units, which can be assembled into a platform or temporary road at the site where they are needed. Upon completion of a project, the construction mats can be lifted up and transported out of the area, preferably to be reused elsewhere.

Environmental regulations often require the use of construction mats for construction and/or maintenance projects. Due to the weather and other environmental conditions during usage at the construction site, construction mats typically are covered with a mixture of water, ice, mud, rock and/or other debris on all the surfaces and within the seams or gaps between the boards of construction mats. Construction mats are typically also loaded with soil-borne pathogens, noxious weeds, destructive insects, anthropogenic contaminants and/or other contaminants that can be transported between sites. As such, environmental regulations often also require construction mats to be cleaned thoroughly before being reused and/or transported between sites to avoid cross contamination of weeds, organisms and other pests.

Prior portable construction mat washing machines utilize high-pressure liquid sprays to remove debris and other contaminants. These washing machines typically include a water holding tank and/or recycling system to filter and reuse the cleaning liquids used and consumed during the washing operation. In addition, these washing machines must either be adapted to receive a source of water or use reclaimed water. During and after washing construction mats, these washing machines must retain and store the wastewater until it may be properly disposed.

Further, these washing machines typically convey the construction mats in a substantially vertical orientation during cleaning. Upon exiting the washing machine, construction mats are immediately moved prior to the next construction mat exiting the machine. The washing machines typically do not provide for ordered stacking of construction mats after completing the washing process.

It is therefore desirable to provide a construction mat cleaning machine and method of use thereof that does not use water, chemical agents or other aqueous or non-aqueous solvents.

It is further desirable to provide a construction mat cleaning machine and method of use thereof that conveys a construction mat in a substantially horizontal, flat orientation.

It is yet further desirable to provide a construction mat cleaning machine and method of use thereof that stacks the construction mats in an orderly fashion upon exiting the cleaning machine.

It is still further desirable to provide a construction mat cleaning machine and method of use thereof that extends the life of the construction mats by utilizing a cleaning process without the use of water, chemical agents or other solvents.

It is yet further desirable to provide a construction mat cleaning machine and method of use thereof that reduces cost and other disposal issues associated with wastewater.

It is still further desirable to provide a construction mat cleaning machine and method of use thereof that prevents wastewater from entering waterways, watersheds and storm drains by utilizing a cleaning process without the use of water, chemical agents or other solvents.

### SUMMARY OF THE INVENTION

In general, in one aspect, the invention relates to a construction mat cleaning machine that does not use water, chemical agents or other aqueous or non-aqueous solvents during a cleaning process. The cleaning machine includes a portable trailer having wheels having a series of rotating conveyor rollers and a series of rotating cleaning rollers connected thereto. The series of rotating conveyor rollers are in a spaced parallel relation forming a path of travel for conveying a horizontally oriented construction mat through the cleaning machine. The series of rotating cleaning rollers are connected to the trailer along the path of travel.

The cleaning machine can also include an exit ramp hingedly connected to the trailer and pivotable between an upright position and a lowered position. The exit ramp may include a ramp frame having at least one of the conveyor rollers mounted thereto. A plane formed by the ramp frame when the exit ramp is in the lowered position has an angle of declination below horizontal. In addition, the cleaning machine may include guide rails connected to the trailer. The guide rails are generally aligned in a spaced parallel relation are disposed longitudinally along the path of travel. A terminal end of one of the guide rails may be flared or angled outwardly from the path of travel.

The conveyor rollers of the cleaning machine may be segmented into entry conveyor rollers, exit conveyor rollers and intermediate conveyor rollers. Further, the conveyor rollers may include idle conveyor rollers, drive conveyor rollers or a combination thereof. The drive conveyor rollers include an array of radially protruding bars, tins or teeth.

The cleaning rollers may be connected to the trailer using mounting plates having an adjustment mechanism to selectively raise or lower the cleaning rollers with respect to the construction mat. Further, the cleaning machine may have cleaning rollers positioned above, below and beside the path of travel, while at least one of the cleaning rollers positioned above the path of travel may be angled with respect to the conveyor rollers. Moreover, the cleaning rollers may be chain rollers, brush rollers or a combination thereof having radially projecting arms or bristles. The projecting arms can be constructed of steel or other resilient, strong material, such as chain or braided steel wire. The projecting bristles can be constructed from a resilient rubber, plastic or any other resilient natural or unnatural material, such as nylon or polyethylene.

In addition, the cleaning machine can include an overhead platform connected to the trailer. A generator for powering hydraulic equipment and/or electrical equipment for operating the cleaning machine may be connected to the platform. Additionally, a control system located remotely from or hingedly connected to the trailer.

### BRIEF DESCRIPTION OF THE DRAWINGS

FIG. 1 is a first side view of an example of a truck and trailer in accordance with an illustrative embodiment of the construction mat cleaning machine and method of use thereof;

FIG. 2 is a second side view of the truck and trailer shown in FIG. 1;

FIG. 3 is a first side view of an example of a construction mat cleaning machine in accordance with an illustrative embodiment of the construction mat cleaning machine and method of use thereof;

FIG. 4 is a second side view of the construction mat cleaning machine shown in FIG. 3;

FIG. 5 is a cross-section view along line 5-5 of the construction mat cleaning machine shown in FIG. 3;

FIG. 6 is a cross-section view along line 6-6 of the construction mat cleaning machine shown in FIG. 3;

FIG. 7 is a cross-section view along line 7-7 of the construction mat cleaning machine shown in FIG. 6;

FIG. 8 is a cross-section view along line 8-8 of the construction mat cleaning machine shown in FIG. 6;

FIG. 9 is a cross-section view along line 9-9 of the construction mat cleaning machine shown in FIG. 6;

FIG. 10 is a cross-section view along line 10-10 of the construction mat cleaning machine shown in FIG. 3;

FIG. 11 is a cross-section view along line 11-11 of the construction mat cleaning machine shown in FIG. 10;

FIGS. 12a and 12b are exploded views of area 12 as shown in FIG. 11;

FIGS. 13a and 13b are side views of an example of an upper angled brush assembly in accordance with an illustrative embodiment of the construction mat cleaning machine and method of use thereof;

FIGS. 14a and 14b are exploded views of area 14 as shown in FIG. 4;

FIG. 15 is a cross-section view along line 15-15 of the construction mat cleaning machine shown in FIG. 10;

FIG. 16 is a cross-section view along line 16-16 of the construction mat cleaning machine shown in FIG. 3;

FIG. 17 is a cross-section view along line 17-17 of the construction mat cleaning machine shown in FIG. 16; and

FIG. 18 is another cross-section view along line 17-17 of the construction mat cleaning machine shown in FIG. 17.

Other advantages and features will be apparent from the following description, and from the claims.

### DETAILED DESCRIPTION OF THE INVENTION

The machines and methods discussed herein are merely illustrative of specific manners in which to make and use this invention and are not to be interpreted as limiting in scope.

While the invention has been described with a certain degree of particularity, it is to be noted that many modifications may be made in the construction and the arrangement of the structural and function details disclosed herein without departing from the scope of the invention. It is understood that the invention is not limited to the embodiments set forth herein for purposes of exemplification.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the machine be constructed or the method to be operated in a particular orientation. Terms, such as “connected,” “connecting,” “attached,” “attaching,” “join” and “joining” are used interchangeably and refer to one structure or surface being secured to another structure or surface or integrally fabricated in one piece unless expressly described otherwise.

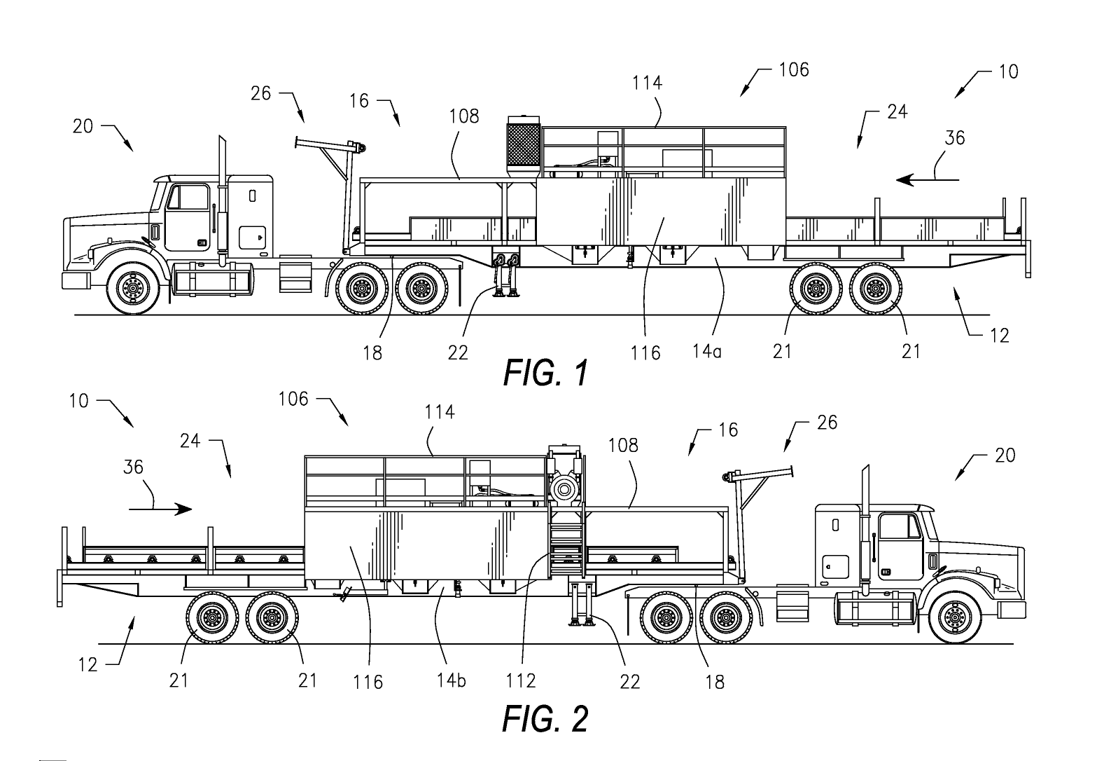

Referring to the figures of the drawings, wherein like numerals of reference designate like elements throughout the several views, and initially to FIGS. 1 through 5, a construction mat cleaning machine 10 constructed on a trailer 12 such that the cleaning machine 10 is portable from one job site to the next. As illustrated, the trailer 12 is a semi-trailer and has a trailer frame 14 constructed of trailer frame rails 14a/b aligned in a generally parallel relation. A front portion 16 of the trailer 12 may include a king-pin 18, which engages with a fifth-wheel coupling (not shown) on a semi-trailer truck 20. The front portion 16 of the trailer 12 may also include adjustable trailer legs 22 to support and level the trailer 12 during usage of the cleaning machine 10 and when disconnected from the truck 20. A rear portion 24 of the trailer 12 is connected to at least one free-rotating axle (not shown) having wheels 21 and brake assemblies (not shown).

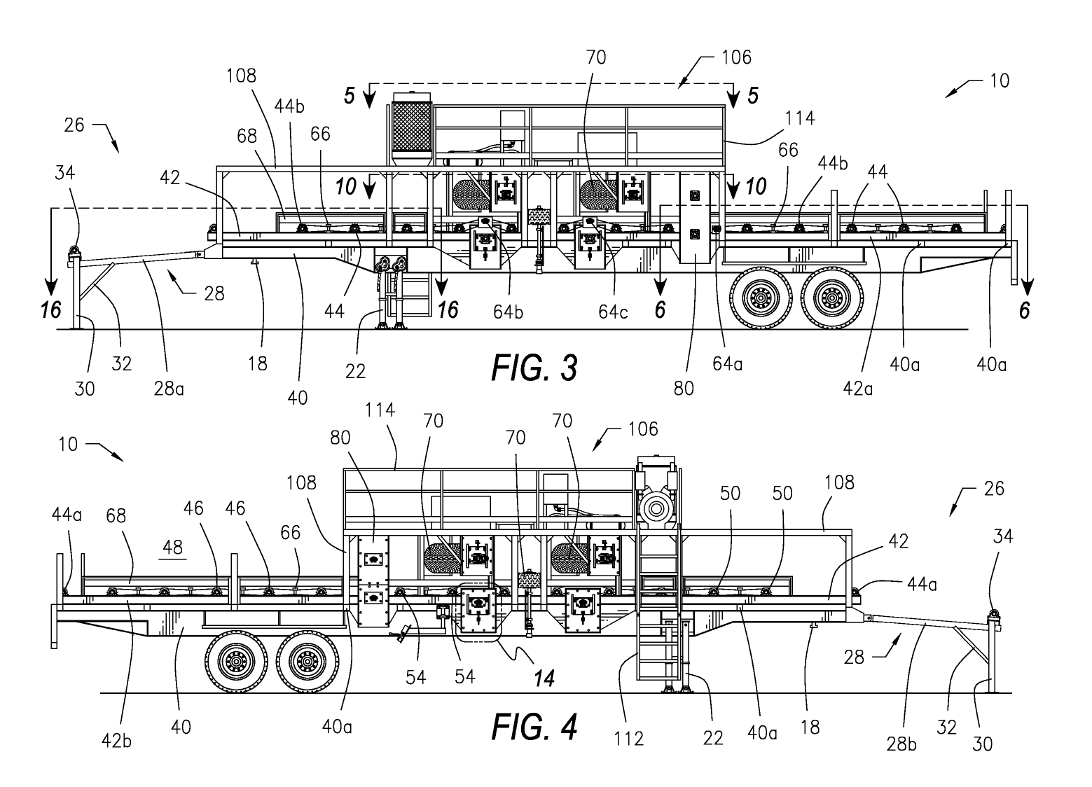

As illustrated in FIGS. 1 through 4, an exit ramp 26 may be attached to the front portion 16 of the trailer 12. The exit ramp 26 is constructed in such a manner to cause construction mats to stack orderly after exiting the cleaning machine 10. The exit ramp 26 is hingedly attached to the trailer frame 14 such that the exit ramp 26 may be pivoted between an upright, transport position, illustrated in FIGS. 1 and 2, and a lowered, working position, illustrated in FIGS. 3 and 4. The exit ramp 26 has a ramp frame 28, which may be constructed ramp side frame rails 28a/b respectively hingedly connected to the trailer 12 and an end ramp frame rail 28c having at least one ramp support leg 30. As illustrated, the support leg 30 is generally perpendicular to the ramp frame 28 and may be strengthened using cross-supports 32. A ramp roller 34 is attached to the end frame rail 28c. The ramp side frame rails 28a/b are generally longitudinally aligned and parallel with a path of travel indicated by arrow 36 for a construction mat 38 to be cleaned. Further, the plane formed by the ramp frame 28, when in the lowered working position, has an angle of declination below horizontal. In addition, the length of the side frame rails 28a/b should be less than the length of typical construction mats.

The cleaning machine 10 includes a sub-frame 40 attached to an upper surface of the trailer frame 14. As illustrated, the sub-frame 40 may be constructed from a plurality of generally parallel sub-frame support members 40a. Each of the sub-frame support members 40a is aligned generally perpendicular to the trailer frame rails 14a/b and to the path of travel 36. The sub-frame support members 40a can be constructed from structural steel having a suitable cross-section, such as depicted as a hollow structural cross-section.

The sub-frame 40 also supports and is connected to a conveyor frame 42. The conveyor frame 42 may be constructed from conveyor frame rails 42a/b. The conveyor frame rails 42a/b are aligned generally perpendicular to the sub-frame support members 40a of the sub-frame 40 and substantially longitudinally with and parallel to the path of travel 36. The conveyor frame rails 42a/b may also be constructed from structural steel, such as depicted as a channel or C-shaped cross-section. Conveyor rollers 44 are attached to an upper surface of the conveyor frame 42 at a substantially perpendicularly orientation to and span the gap between the conveyor frame rails 42a/b. The conveyor rollers 44 are attached to the conveyor frame 42 in a spaced relation and aligned in parallel to one another. The conveyor rollers 44 may be segmented into entry conveyor rollers 46 positioned at an entrance opening 48 of the trailer 12, exit conveyor rollers 50 positioned at an exit opening 52 of the trailer 12, and intermediate conveyor rollers 54 positioned between of the entry conveyor rollers 46 and the exit conveyor rollers 50.

The conveyor rollers 44 may be idle rollers 44a, drive rollers 44b, a combination thereof or any other device known in the art to be used for or in connection with conveyors. The entry conveyor rollers 46 and the exit conveyer rollers 50 may each respectively include one or many idle rollers 44a and/or drive rollers 44b, while the intermediate conveyor rollers 54 should include drive rollers 44b. The idle rollers 44a may have a smooth exterior circumference, and as shown in FIG. 9, while the drive rollers 44b may include an array of radially protruding bars, tins or teeth 56 to aid in moving construction mats 38 along the path of travel 36 during the cleaning process.

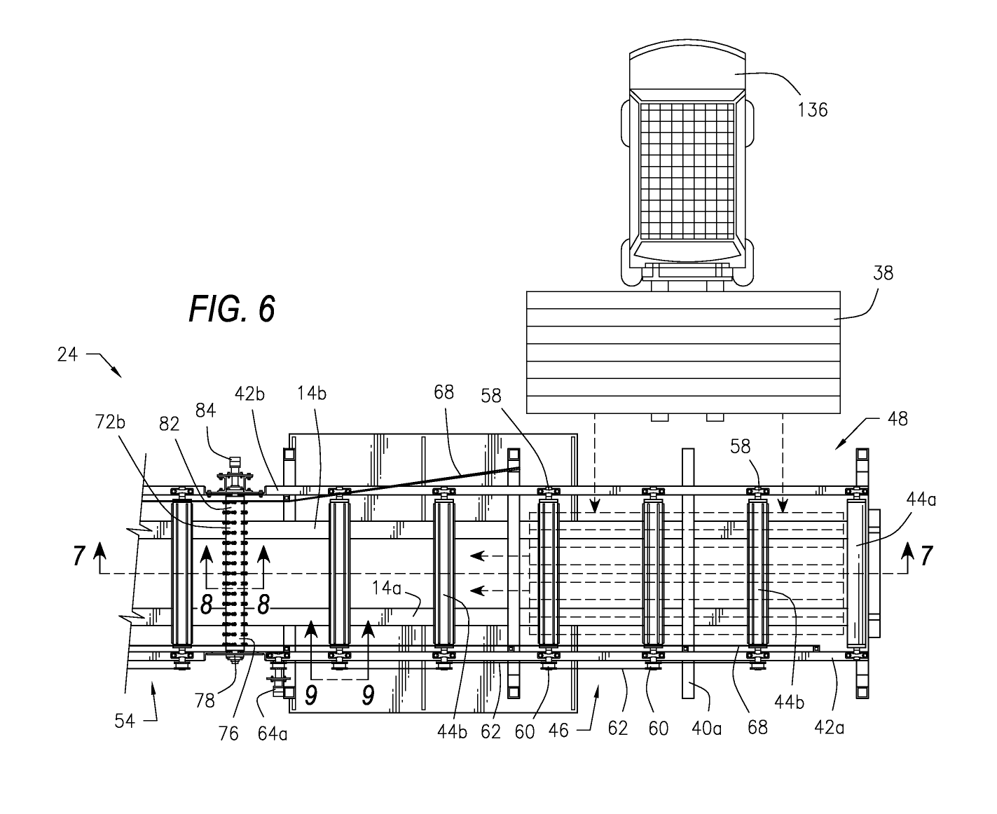

The conveyor rollers 44 may be journaled in bearings 58, such as pillow block bearings, which are attached to the conveyor frame 42. Further, the conveyor rollers 44 that are drive rollers 44b may also include at least one drive sprocket 60 engaged with a drive chain 62, and as can be seen in FIG. 6, but not by way of limitation, the drive rollers 44b may include a pair of drive sprockets 60. Adjacent drive rollers 44b of each conveyor roller segment 46, 50 or 54 may be linked with the drive chain 62 to allow the drive rollers 44b to be powered in series. A person having ordinary skill in the art will appreciate that each drive roller 44b could be respectively powered by a motor 64 or an activator 64, or the motor may power multiple drive rollers 54b, as exemplified. In addition, a chain tensioner 66 can be provided for each drive chain 62, and be positioned intermediate of adjacent drive rollers 44b. For purposes of exemplification, entry motor 64a may power the entry conveyor rollers 46, exit motor 64b may power the exit conveyor rollers 50, and an intermediate motor 64c may power the intermediate conveyor rollers 54.

The cleaning machine 10 also includes guide rails 68 disposed longitudinally along the path of travel 36. The guide rails 68 are aligned in parallel in order to direct construction mats 38 through the cleaning machine 10 during the cleaning process. The guide rails 68 form the entrance opening 48 to the cleaning machine 10 at the rear portion 34 of the trailer 12, while at the front portion 16 of the trailer 12, the guide rails 18 form the exit opening 52. The guide rails 68 are aligned above the plane defined by the top portion of the conveyor rollers 44, and as shown in FIG. 6, a terminal end of one of the guide rails 68 may be outwardly angled to prevent binding of construction mats 38 initially being conveyed during the cleaning process.

During the cleaning process, the cleaning machine 10 uses a series of dry, resilient cleaning rollers 70 to remove debris and other contaminants from the construction mats 38. The cleaning rollers 70 may be any roller having radially projecting arms or bristles. The cleaning rollers 70 may include chain rollers 72 horizontally oriented and connected to the cleaning machine 10. As can be seen in FIG. 8, the chain rollers 72 have radially projecting arms 74 constructed of steel or other resilient, strong material (e.g., chain, braided steel wire, etc.) capable of removing large debris and other contaminants on the surfaces and within the seams or gaps between the boards of construction mats 38. The radially projecting arms 74 may be attached to the chain roller 72 in any suitable manner (e.g., welding, cable ties, clamps, etc.). The chain rollers may 72 be journaled in a parallel, spaced relation, with an upper chain roller 72a journaled above the conveyor frame 42 and a lower chain roller 72b journaled along the conveyor frame 42. As illustrated in FIG. 6, one terminal end 76 of the chain rollers 72 may be journaled in bearings 78, depicted as pillow block bearings, which are secured to roller supports 80 attached to the trailer frame 14, and the other terminal end 82 of the chain rollers 72 are journaled to a motor 84 for powering the chain roller 72. The chain rollers 72 are parallel to the conveyor rollers 42 and may be positioned between the entry conveyor rollers 46 and the intermediate conveyor rollers 54 along the path of travel 36.

The cleaning rollers 70 may also include brush rollers 86 having radially projecting bristles 75 constructed of a resilient rubber, plastic or any other resilient natural or unnatural material (e.g., nylon, polyethylene, etc.). The brush rollers 86 are also horizontally oriented and may include upper brush rollers 86a, lower brush rollers 86b and side brush rollers 86c. The upper brush rollers 86a are journaled in a parallel, spaced relation above the conveyor frame 42, while the lower brush rollers 86b are journaled in a parallel, spaced relation along the conveyor frame 42. The upper brush rollers 86a may be angled with respect to the conveyor rollers 44, such as at a 30 degree angle, while the lower brush rollers 86b may be in parallel relation with the conveyor rollers 44. As shown by way of exemplification, a first set 88 of upper and lower brush rollers 86a/b may be disposed along the intermediate conveyor rollers 54, while a second set 90 of upper and lower brush rollers 86a/b may be disposed along the exit conveyor rollers 50.

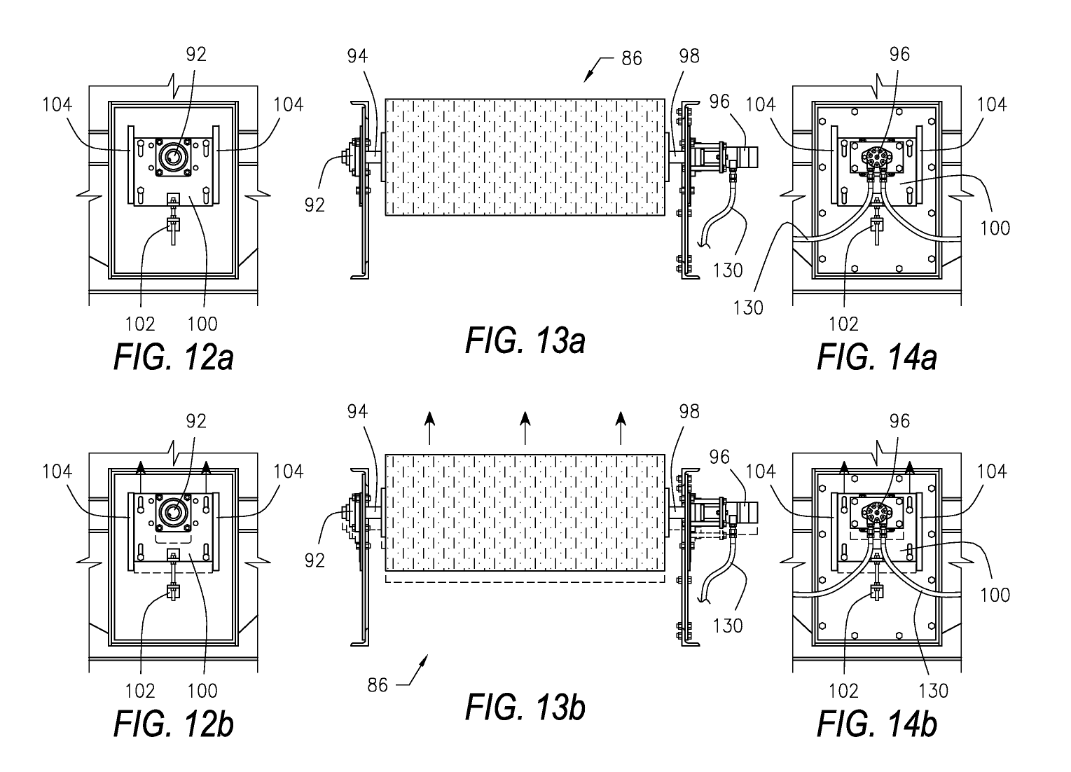

As shown in FIGS. 12 through 14, the upper brush rollers 86a and the lower brush rollers 86b may be journaled in bearings 92 at one terminal end 94 and in a motor 96 at the other terminal end 98. The bearings 92 and motor 96 are secured to mounting plates 100, which are adjustably connected to brush supports 80. The roller supports 80 are attached to the trailer frame 14 of the trailer 12. The position of the mounting plates 100 may be adjusted using an adjustment mechanism 102 in order to raise/lower the brush rollers 86 between the positions illustrated in FIGS. 13a and 13b. The brush rollers 86 may be moved closer together or further apart for the purpose of controlling the tension against the conveyed construction mats 38. The mounting plates 100 may be engaged between shoulder tracks 104 for slideable adjustment. A person having ordinary skill in the art will appreciate other modes of adjusting the position of the mounting plates 100 and/or the position of the brush rollers 86, both manual and automated, may be utilized in keeping with the scope of the cleaning machine 10.

Similarly to the upper and lower brush rollers 86a/b, the side brush rollers 86c may also be journaled in a parallel, spaced relation along the conveyor frame 42. The side brush rollers 86c are, however, vertically oriented and positioned on opposing sides of the conveyor or frame 42. Further, the side brush rollers 86c may be positioned between the intermediate conveyor rollers 54 and the exit conveyor rollers 50. Additionally, the side brush rollers 86c can be disposed intermediate of the first set 88 and the second set 90 of upper and lower brush rollers 86a/b. Similar to other brush rollers 86, the side brush rollers 86c may be any roller having radially projecting bristles 75 constructed of a resilient rubber, plastic or any other natural or unnatural material (e.g., nylon, polyethylene, etc.).

During operation, the upper chain roller 72a contacts and cleans the upper surface of construction mats 38, while the lower chain roller 72b contacts and cleans the lower surface of construction mats 38. Construction mats 38 are then conveyed to the brush rollers 86 where the upper and lower brush rollers 86a/b contact and clean the upper and lower surfaces, while the side brush rollers 86c contact and clean the edge surfaces of any remaining debris and contaminants as construction mats 38 are conveyed along the path of travel 36 during the cleaning process. The cleaning rollers 70 may each be operatively connected to a pressure sensitive switch (not shown) to automatically activate the respective roller 70 upon contact with conveyed construction mats 38 during the cleaning process. Furthermore, the cleaning rollers 70 may be operatively spring-loaded to maintain continuous contact with conveyed construction mats 38 and also to allow the cleaning rollers 70 to adjust to irregularities between construction mats 38.

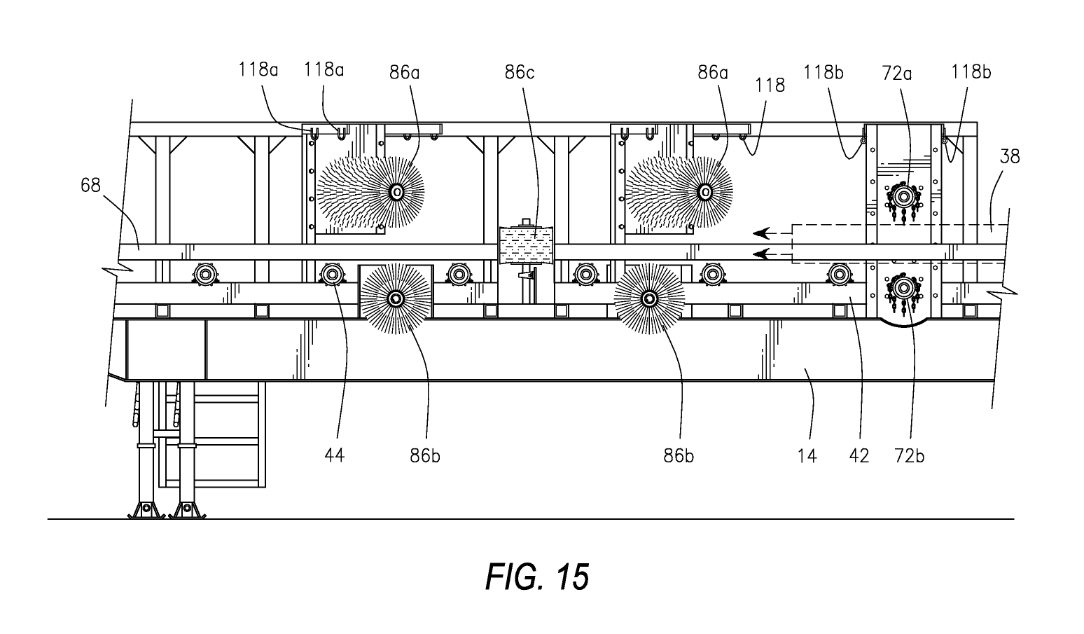

Equipment for operating the cleaning machine 10 and spare parts (e.g., spare brushes in varying sizes, etc.) (not shown) may be secured to and supported by a platform 106. The platform 106 is supported by and connected to the trailer frame 14 of the cleaning machine 10. The platform 106 may be constructed from a platform frame 108 that is attached to the sub-frame 40 and supports a platform floor 110. A ladder 112 may be connected to the platform frame 108 providing a user access to the platform floor 110. Also, a safety railing 114 may be connected to the platform frame 108 to prevent the user from inadvertently falling from the platform 106. Additionally, side covers 116 may be removably attached to the sides of the platform frame 108. The side covers 116 block debris from flying off construction mats 38 during the cleaning process and/or to protect the cleaning machine 10 while the trailer 12 is being transported between job sites. As shown in FIG. 15, the platform 106 may include a series of attachment mechanisms 118, such as depicted as generally U-shaped brackets 118a and eyehooks 118b attached to the lower surface of the platform frame 108. It will be appreciated that the attachment mechanisms 118 can take other structural forms to aid in lifting and suspending the cleaning rollers 70 or other equipment during maintenance of the cleaning machine 10.

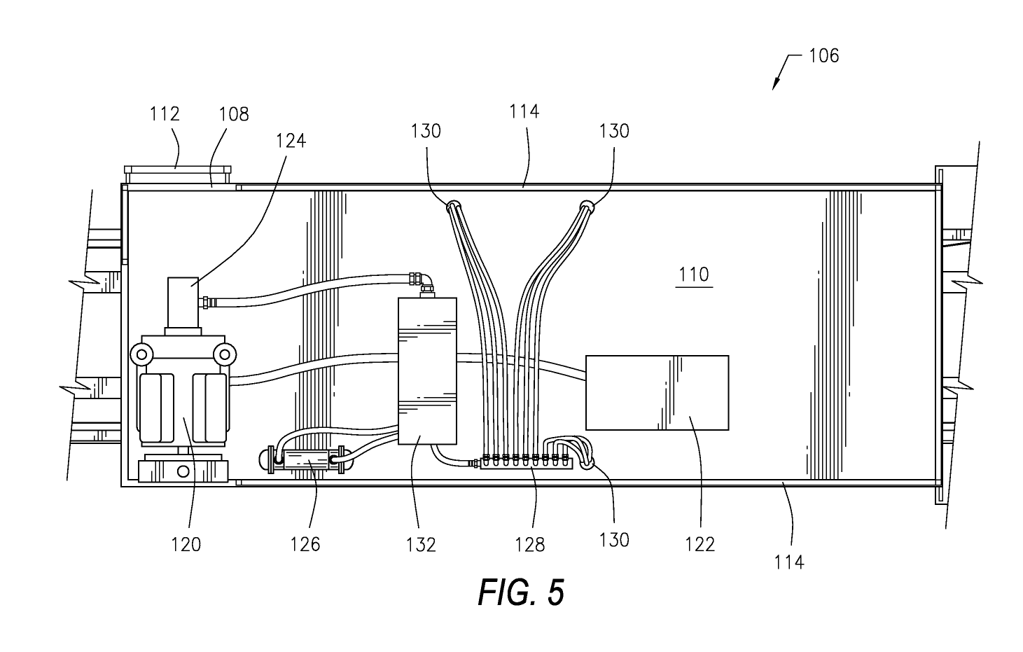

As seen in FIG. 5, a generator 120 is secured to the platform 106 and is in fluid communication with a fuel storage vessel 122, which may also be secured to the upper surface of the platform floor 110. For purposes of illustration and not limitation, the generator 120 powers hydraulic equipment for operating of the cleaning machine 10; however, it will be appreciated by a person having ordinary skill in the art that the cleaning machine 10 may alternatively be operated using electrical power. Since no water or other liquids are used during the cleaning process, the cleaning machine 10 may be operated using electrical equipment without fear of electrocution and/or other hazards associated with using electricity in wet environments. For example, the cleaning machine 10 may be operated by a series of high torque electric motors (not shown) capable of operating at variable speeds.

The generator 120 is connected to and powers a hydraulic pump 124 that transmits hydraulic fluid to various hydraulic motors and actuators (64, 84 and 96) disposed throughout the cleaning machine 10. The hydraulic pump 124 may be in fluid communication with a heat exchanger 126, which is secured to the platform 10, for warming the hydraulic fluid during cold operating conditions. The fluid is controlled directly or automatically by control valves 128 and distributed through hoses and tubes 130 to the desired motor/actuator of the cleaning machine 10. The hydraulic pump 124 may include a fluid reservoir 132 to hold excess hydraulic fluid in order to accommodate for volume changes, such as from actuator operation or temperature expansion.

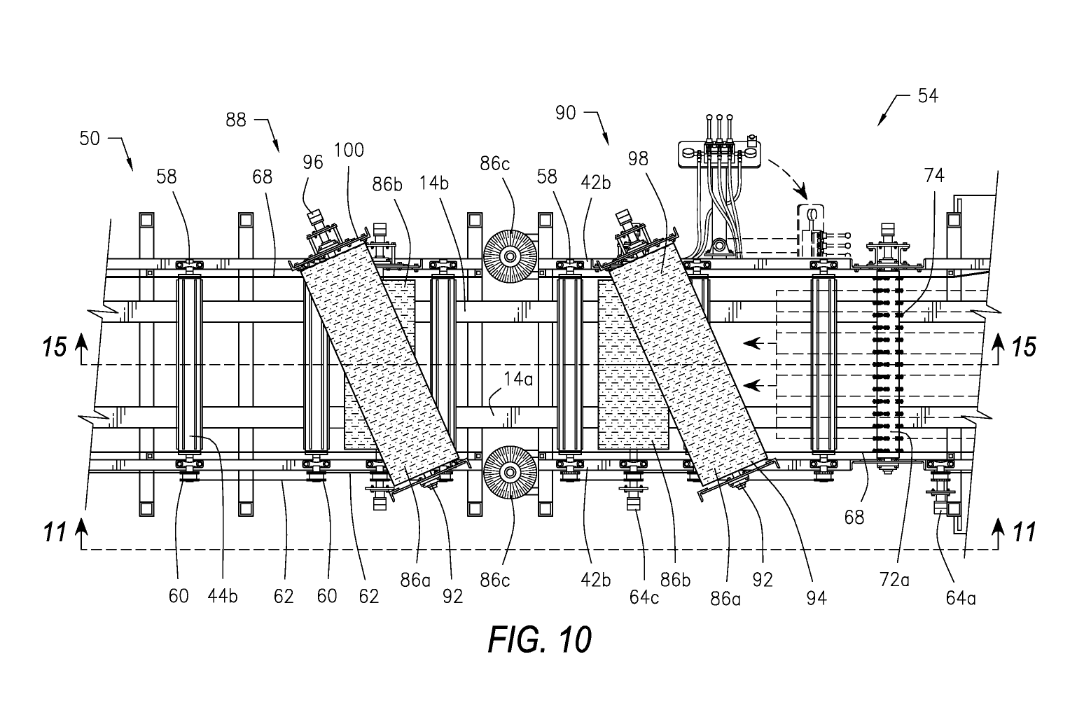

As shown in FIG. 10, the cleaning machine 10 is controlled by a control system 134, which can be located remotely from the trailer 12, or which can be hingedly mounted to the trailer 12. As depicted, the control system 134 is moveable between an operating position and a travel position, allowing the user to selectively operate the cleaning machine 10.

A secondary conveyor (not shown) may also be installed under the conveyor frame 42 or under the trailer 12 to catch and remove debris and other contaminants released from construction mats 38 during the cleaning process. The secondary conveyor can be connected with a pit or dump truck/trailer (not shown) to automatically remove the debris and other contaminants.

The cleaning process performed by the cleaning machine 10 does not use water, chemical agents or other aqueous or non-aqueous solvents to remove debris and other contaminants from construction mats 38. Generally during operation, the construction mat 38 is lifted by a crane, backhoe or front-end loader 136 and moved through the entrance opening 48 of the cleaning machine 10. The construction mat 38 is placed in a flat, horizontal orientation and is conveyed along the path of travel 36 during the cleaning process. A series of rotating cleaning rollers 70 remove debris and contaminants from all surfaces and within the seams of the construction mats 38. The cleaned construction mats 38 exit the exit opening 52 of the cleaning machine 10 and are passed to the exit ramp 26, which stacks cleaned construction mats 38 in an orderly and organized fashion on the ground. The front-end loader 136 then moves the stacked and cleaned construction mats 38 to another location so that the cleaning machine 10 can continue to operate.

As illustrated throughout the figures of the drawings, in one aspect of operation, after arriving at a particular job site, the fifth-wheel coupling of the truck 20 is disengaged from the king-pin 18 on the trailer 12, and the trailer legs 22 are lowered to the ground to support the front portion 16 of the trailer 12, as can be seen in FIGS. 3 and 4. The height of the trailer legs 22 may be adjusted so that the plane defined by the top portion of the conveyor rollers 44 is generally horizontal. The exit ramp 26 is pivoted from the upright, transport position, shown in FIGS. 1 and 2, to the lowered, working position, shown in FIGS. 3 and 4. The height of support legs 30 of the exit ramp 26 may be adjusted, if necessary, such that the plane defined by the top portion of the ramp roller 34 and the idle exit conveyor roller 44a is downwardly angled with respect to the plane defined by the top portion of the exit conveyor rollers 50. Once the cleaning machine 10 is setup at the job site, the trailer brake assemblies are engaged and/or the wheels 21 are chocked (not shown) to ensure the cleaning machine 10 is stable during the cleaning process.

To start the cleaning process, the front-end loader 136 moves a construction mat through the entrance opening 48 at the rear portion 24 of the trailer 12 and places the contraction mat 38 on the entry conveyor rollers 46. Once the front-end loader 136 clears the working area, the cleaning machine 10 may be activated causing the conveyor 44 to rotate. The cleaning rollers 70 may also activate when the conveyor rollers 44 are activated, or alternatively, may be selectively activated using the control system 134 or automatically activated using the pressure sensitive switch. As the conveyor rollers 44 rotate, the radially protruding teeth 56 of the drive rollers 44b engage the construction mat 38 moving it through the cleaning machine 10. The construction mat 38 is guided along the path of travel 36 by the guide rails 68, and initially, the outward angle of the guide rail 68 prevents initial binding of the construction mat 38.

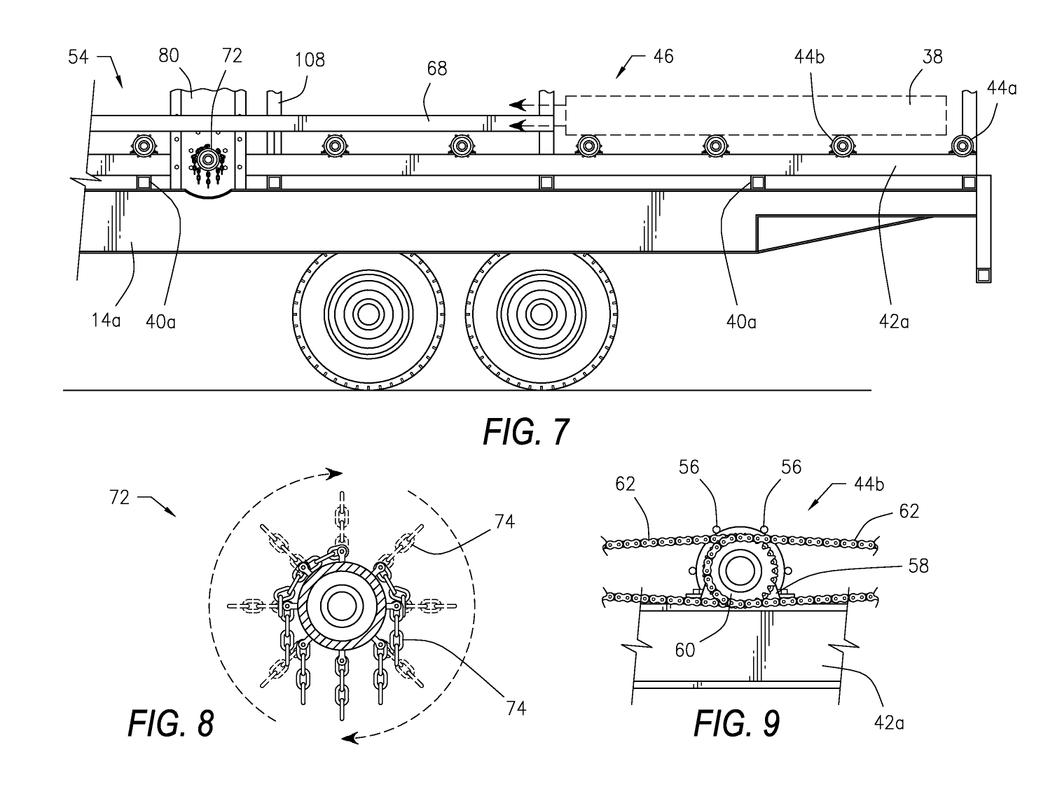

As illustrated in FIGS. 6 and 7, the entry conveyor rollers 46 move the construction mat 38 from the entrance opening 48 toward the cleaning rollers 70. As illustrated, the construction mat 38 is first conveyed through chain rollers 72 that are rapidly rotating causing the arms 72 to radially project, as seen in FIG. 8, and respectively engage the upper surface and the lower surface of the construction mat 38 to initially remove large debris and other contaminants. If utilized, the secondary conveyor may collect and remove debris and contaminants that have been removed from the construction mat 38 by the chain rollers 72.

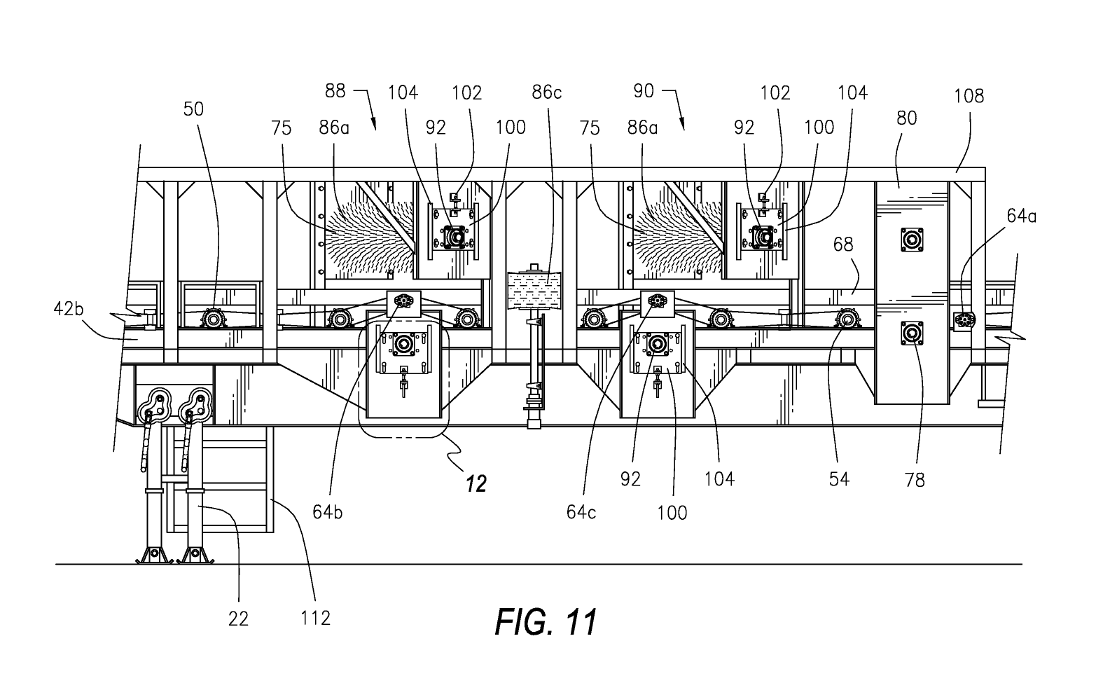

The construction mat 38 may then be conveyed from the entry conveyor rollers 46 to the intermediate conveyor rollers 54 positioned downstream from the chain rollers 72. As shown in FIGS. 10, 11 and 15, the upper surface of the construction mat 38 is cleaned by the angled upper brush roller 86a, while the lower surface of the construction mat is cleaned by the lower brush roller 86b. The construction mat 38 may then be conveyed to the side brush rollers 86c, which are positioned between the intermediate conveyor rollers 54 and the exit conveyor rollers 50. As the construction mat 38 is being conveyed from the intermediate conveyor rollers 54 to the exit conveyor rollers 50, the side brush rollers 86c clean the edge surfaces of the construction mat 38. The construction mat 38 is conveyed along the path of travel 36 from the side brush rollers 86c to additional cleaning rollers 70 remove any remaining debris or contaminants that were not yet removed during the cleaning process. Similarly, the upper and lower surfaces of the construction mat 38 may be respectively cleaned by the angled upper brush roller 86a and the lower brush roller 86b. If utilized, the secondary conveyance would remove debris and contaminants that have been removed from the construction mats 38 by the brush rollers 86.

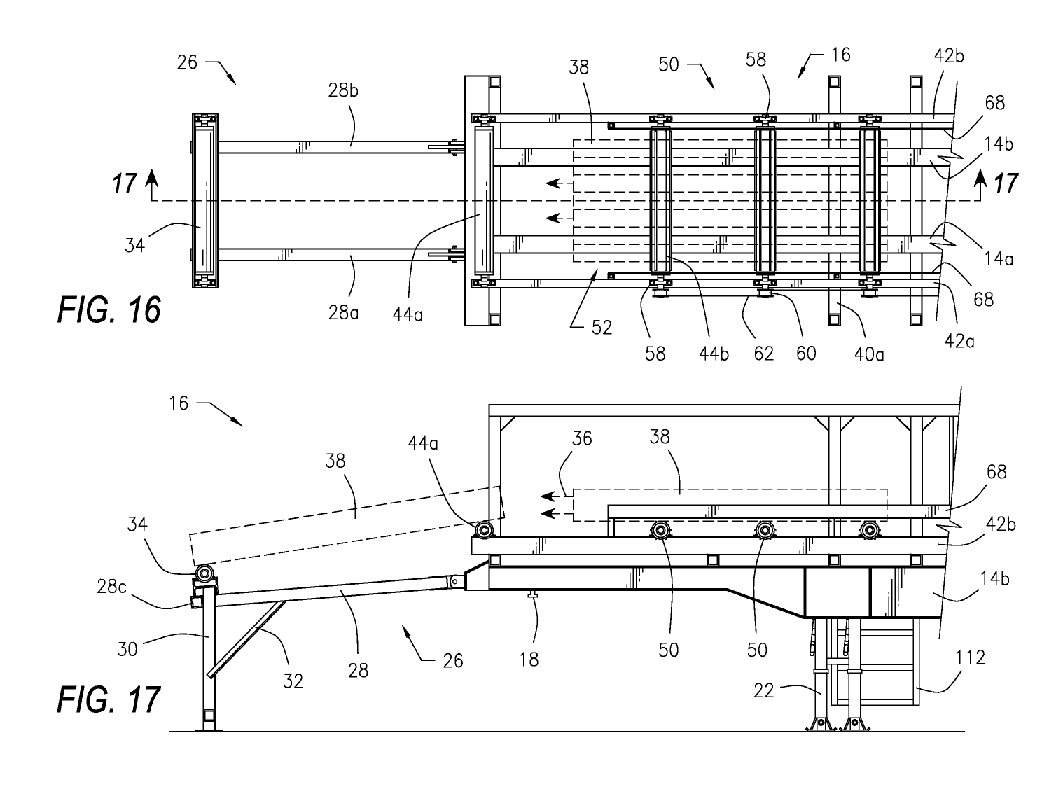

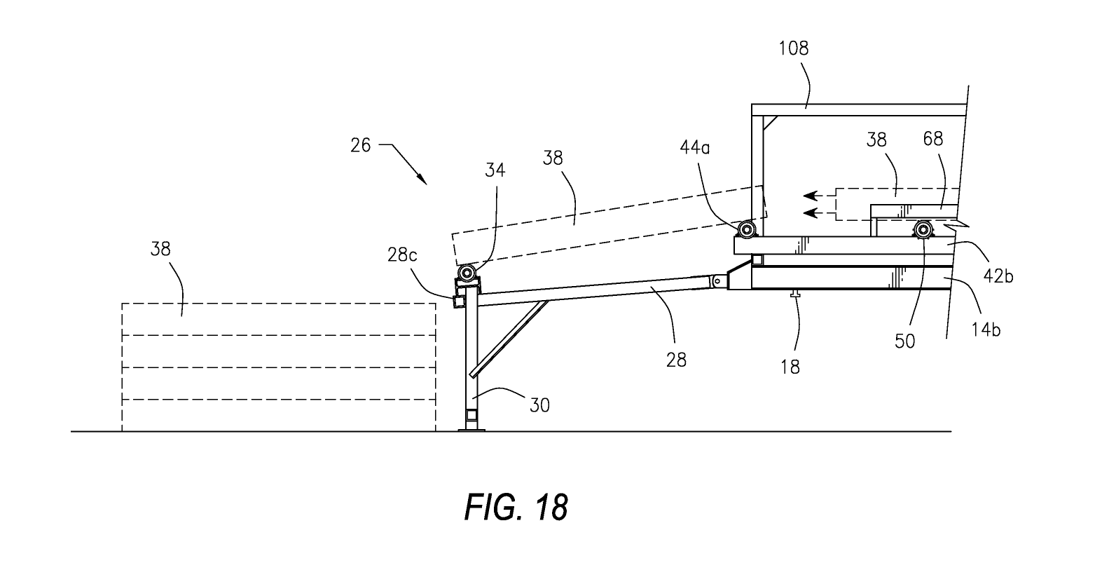

As seen in FIGS. 16 through 18, the construction mat 38 may be further conveyed by the exit conveyor rollers 50 towards the exit opening 52 and the exit ramp 26. As the construction mat 38 is conveyed along the exit conveyor rollers 50, the leading edge of the construction mat 38 moves along the idle exit conveyor roller 44a and onto the ramp roller 34. The ramp roller 34 guides the construction mat 38 to the ground in an orderly fashion so that multiple cleaned construction mats 38 can be stacked. Once a sufficient number of construction mats 38 have been cleaned and stacked, the front-end loader 136 may transport the construction mats 38 away from the cleaning machine 10.

In addition, a counter (not shown) may be operatively installed on the cleaning machine 10 to keep an accurate count of the number of construction mats 38 cleaned. This information may be operatively linked to a computing device (not shown) so that the user and/or customer can track and monitor the cleaning process in real-time or near real-time.

It will also be appreciated that additional cleaning rollers 70, chain rollers 72 and/or brush rollers 86 may be utilized on the cleaning machine 10 in order to provide added cleaning if needed. In addition, the chain rollers 72 and brush rollers 86 of the cleaning machine 10 may be positioned in differing orders than as set forth herein for purposes for exemplification. Further, while the cleaning machine 10 is discussed with regard to segments of entry, exit and intermediate conveyor rollers 46, 50 and 54, it will be appreciated that cleaning machine should not be so limited and may be constructed using a contiguous series of conveyor rollers 44.

Moreover, the path of travel 36 of construction mats 38 may be reversed such that construction mat 38 enter from the front portion 16 of the trailer 12 and exit from the rear portion 24 of the trailer 12. In this alternate example, the exit ramp 26 would be hingedly connected to the rear portion 24 of the trailer 12. Moreover, the path of travel 36 of construction mats 38 may be reversed after the cleaning process such that construction mats 38 travel upstream on the conveyor rollers 44 in order to be re-cleaned.

Whereas, the machines and methods have been described in relation to the drawings and claims, it should be understood that other and further modifications, apart from those shown or suggested herein, may be made within the scope of this invention.

What is claimed is:

1. A construction mat cleaning machine that does not use water, chemical agents or other aqueous or non-aqueous solvents during a cleaning process, said cleaning machine comprising:
a portable trailer having wheels;
a series of rotating conveyor rollers connected to said trailer in a spaced parallel relation forming a path of travel for conveying a horizontally oriented construction mat; and
a series of rotating cleaning rollers connected to said trailer along said path of travel.

2. The cleaning machine of claim 1 further comprising an exit ramp hingedly connected to said trailer and pivotable between an upright position and a lowered position.

3. The cleaning machine of claim 2 wherein said exit ramp includes a ramp frame having at least one of said conveyor rollers mounted thereto.

4. The cleaning machine of claim 3 wherein a plane formed by said ramp frame when said exit ramp is in said lowered position has an angle of declination below horizontal.

5. The cleaning machine of claim 1 further comprising guide rails connected to said trailer, said guide rails generally aligned in a spaced parallel relation, and said guide rails disposed longitudinally along said path of travel.

6. The cleaning machine of claim 5 wherein a terminal end of one of said guide rails is outwardly angled from said path of travel.

7. The cleaning machine of claim 1 wherein said conveyor rollers comprise entry conveyor rollers, exit conveyor rollers and intermediate conveyor rollers.

8. The cleaning machine of claim 1 wherein said conveyor rollers comprise idle conveyor rollers, drive conveyor rollers or a combination thereof.

9. The cleaning machine of claim 8 wherein said drive conveyor rollers include an array of radially protruding bars, tins or teeth.

10. The cleaning machine of claim 1 further comprising said cleaning rollers connected to said trailer using mounting plates having an adjustment mechanism to selectively raise or lower said cleaning rollers with respect to said construction mat.

11. The cleaning machine of claim 1 wherein said cleaning rollers are positioned above, below and beside said path of travel.

12. The cleaning machine of claim 11 wherein at least one of said cleaning rollers positioned above said path of travel is angled with respect to said conveyor rollers.

13. The cleaning machine of claim 1 wherein said cleaning rollers comprise chain rollers, brush rollers or a combination thereof having radially projecting arms or bristles.

14. The cleaning machine of claim 13 wherein said projecting arms are constructed of steel or other resilient, strong material.

15. The cleaning machine of claim 14 wherein said resilient material is selected from the group consisting of chain or braided steel wire.

16. The cleaning machine of claim 13 wherein said projecting bristles are constructed from a resilient rubber, plastic or any other resilient natural or unnatural material.

17. The cleaning machine of claim 16 wherein said resilient material is selected from the group consisting of nylon or polyethylene.

18. The cleaning machine of claim 1 further comprising an overhead platform connected to said trailer.

19. The cleaning machine of claim 1 further comprising a generator for powering hydraulic equipment and/or electrical equipment for operating said cleaning machine.

20. The cleaning machine of claim 1 further comprising a control system located remotely from or hingedly connected to said trailer.
